(19) United States
(12) Patent Application Publication
(10) Pub. No.: US 2002/0177538 A1
(43) Pub. Date: Nov. 28, 2002

(54) Acid demulsifier hydrocarbon process deposit removal treatment and compositions

(75) Inventors: Paul R. Hart, Woodlands, TX (US); Michelle Moffitt, Shepherd, MT (US)

Correspondence Address: HOFFMANN & BARON, LLP, 6900 JERICHO TURNPIKE, SYOSSET, NY, 11791, US

(73) Assignee: Hercules Incorporated

(21) Appl. No.: 09/809,692

(22) Filed: Mar. 15, 2001

(51) Int. Cl. B08B 3/00; C23G 1/02; B08B 9/00; C23G 1/00; C03C 23/00; B08B 1/00; B08B 9/027; C11D 1/00

(52) U.S. Cl. 510/188; 134/26; 134/2; 134/3; 134/22.1; 134/22.11; 134/14; 134/22.19; 134/28; 134/36; 134/41

(57) ABSTRACT

Compositions for removing deposits from the interior surfaces of oil refining equipment are provided. The compositions include an organic oil-soluble or oil-miscible acid and a multi-polyether-headed surfactant (MPEHS). Methods of removing these deposits from the interior surfaces of oil refining equipment and removing mud deposits from the bottom of desalters, while the equipment is online, are also disclosed.

### FIELD OF THE INVENTION

The present invention relates to methods and compositions for online removal of deposits from hydrocarbon processing equipment. More specifically, the present invention relates to the removal of deposits that are water-insoluble, marginally water-insoluble, or otherwise are not able to be removed by conventional water wash, by converting them to water-soluble salts or complexes by the use of a strong acid.

### BACKGROUND OF RELATED TECHNOLOGY

Refinery operating units are made up of various types of vessels such as tanks, heat exchangers, catalytic reactors, flowlines, distillation towers, desalters, crackers, hydrotreaters, and the like. The crude oil or other hydrocarbon streams that are processed by this equipment include several impurities that over time produce deposits that accumulate on the interior surfaces of the equipment, detrimentally effecting the efficiency of processing and the quality of the final hydrocarbon products. These deposits include various salts, scales, and corrosion products, such as NH₄Cl, CaCO₂, FeO₂H, and FeS. These impurities either coat the interior surfaces of the equipment, including mud or sludge within the desalters settle to the bottom, or are carried downstream. Therefore, this equipment must be cleaned regularly to provide continued efficiency of hydrocarbon processing.

The nature of the deposits makes them resistant to conventional methods of cleaning. The inorganic deposits are usually covered by a layer of organics which prevents them from being removed by conventional water washes. In addition, salts of CO₂ and H₂S are only slightly water-soluble, compounding the ineffectiveness of their removal by water washes. Therefore, in order to provide effective cleaning, the equipment was required to be shut down and disassembled.

Conventional aqueous cleaning treatments containing ionic or only mono-polyether-headed surfactants cannot be used on-line because they emulsify the water wash with the hydrocarbon being processed, causing numerous separation and redeposition problems downstream. Therefore, the processing equipment must be shut down prior to treatment which is time consuming and costly, both in repair and maintenance costs as well as in lost production time.

In order to save time and labor costs, an inhibited acid wash can be utilized during shutdown that does not require disassembly or access to the inside of the process equipment or component parts. For example, U.S. Pat. No. 4,276,185 to Martin discloses a composition and method for contacting an inhibited acid wash with process equipment components. However, contacting processing equipment with a pure treatment composition requires the process vessel to be taken offline. Although the use of a chemical composition that avoids disassembly of the process vessel is useful, the process in Martin still required a shutdown.

An aqueous solution of a strong acid would be corrosive to the process equipment. Strong acids that are present during the refining process can cause corrosion of the interior surfaces of the equipment and produce deposition of corrosion products. Also, the addition of an aqueous strong acid can cause the hydrocarbon to form an emulsion with the water that is difficult to separate. The conventional water washes that have been employed do not aggravate the problems caused by the presence of acids, although they are generally ineffective at removing the corrosion products that are produced because the corrosion products tend to be only sparingly soluble in water.

Additional methods have been described for removing deposits from process equipment components. For example, U.S. Pat. No. 4,003,856 to Sharp discloses a linear diamine composition that provides for breakup of iron sulfide into finely divided solids which can be removed downstream. U.S. Pat. No.4,032,360 also to Sharp provides a method for using a linear diamine composition. Breaking up the solid forms of iron sulfide and associated fouling into solid particles, however, is not ideal in that solid particles can clog many process configurations including distillation towers, where solid particles can interfere with liquid-vapor flow contacting tray geometries.

Co-pending U.S. patent application ser. No. 09/631,796 filed on Aug. 3, 2000 and entitled “Methods And Compositions For Removing Metal Sulfide Deposits From Metal Surfaces” discloses the use of a water-soluble acid and surfactant composition to remove metal sulfide deposits. The method of removing the metal sulfide deposits may be administered while the equipment is in use.

It is desirable to provide methods and compositions for the removal of deposits that may be administered without the equipment being shut-down, providing cost-effectiveness. It would be further desirable to provide methods and compositions that convert the generally non-water-soluble deposits to water-soluble salts that can be removed by a water wash without harming the system by causing problems of emulsification and corrosion. It is also desirable to provide methods and compositions that may incorporate the use of a strong acid that avoids the problems of corrosion while being administered during the operation of the equipment.

### SUMMARY OF THE INVENTION

One aspect of the present invention relates to compositions for removing salt deposits and salt-containing mud deposits from the interior surfaces of hydrocarbon processing equipment that includes at least one organic oil-soluble or oil-miscible acid and at least one multi-polyether-headed surfactant. These compositions optionally include at least one organic solvent. Desirably, these compositions are substantially free of water.

Another aspect of the present invention provides a method for the removal of salt deposits and salt-containing mud deposits from the interior surfaces of hydrocarbon processing equipment. The first step of this method includes preparing a composition that includes at least one organic oil-soluble or oil-miscible acid and at least one multi-polyether-headed surfactant. The composition is then added to the influent of the hydrocarbon processing equipment, desirably while it is still online. Finally, a water based solution is added to the influent to provide a water wash. The composition of this method may also include at least one organic solvent. The method is desirably employed while the hydrocarbon processing equipment is online.

A further aspect of the present invention provides a method for removing salt-containing mud deposits from the inside of a crude oil desalter. The method includes the steps of preparing a composition that includes at least one organic oil-soluble or oil-miscible acid and at least one multi-polyether-headed surfactant and adding this composition to the desalter. After this addition, the mud deposit may be flushed with a mud-wash system. The method is desirably employed while the hydrocarbon processing equipment is online.

A still further aspect of the present invention provides a kit for removing salt deposits from a surface. This kit includes at least one organic oil-soluble or oil-miscible acid, at least one multi-polyether-headed surfactant, and at least one organic solvent.

An even further aspect of the present invention provides a composition for the removal of salt deposits and salt-containing mud deposits from the interior surfaces of hydrocarbon processing equipment. This composition includes at least one organic oil-soluble or oil-miscible acid that is capable of converting substantially water-insoluble deposits into water-soluble salts or water-soluble complexes. The composition also includes at least one multi-polyether-headed surfactant that is capable of acting as a tar removal agent that does not emulsify water with hydrocarbons.

Another, still further aspect of the present invention provides a method for the removal of salt deposits and salt-containing mud deposits from the interior surfaces of hydrocarbon processing equipment by converting the deposits into water-soluble salts and water-soluble complexes. The first step includes the preparation of a composition that includes at least one organic oil-soluble or oil-miscible acid that is capable of converting substantially water-insoluble deposits into water-soluble salts or water-soluble complexes. The composition also includes at least one multi-polyether-headed surfactant that is capable of acting as a tar removal agent that does not emulsify water with hydrocarbons. The composition is allowed to contact the deposit for a sufficient time to convert the deposit to a water-soluble salt or water-soluble complex. These water-soluble salts and complexes are then removed by flushing with an aqueous solution.

### BRIEF DESCRIPTION OF THE DRAWINGS

FIG. 1 is a bar graph demonstrating the effectiveness of a method of the removal of mud or sludge deposits from a desalter, showing delta T along the y-axis, measured in degrees Fahrenheit, which is the difference between the temperature of the desalter and the temperature in the desalter at a particular Sample Point, labeled A through I, on the x-axis.

### DETAILED DESCRIPTION OF THE INVENTION

The present invention is directed to compositions and methods for the removal of deposits from the interior surfaces of hydrocarbon processing equipment. Desirably, these methods may be employed while the equipment is online, thereby avoiding the additional expense associated with the loss of production time while the equipment is shut-down and the cost of disassembling and reassembling the equipment. In addition, the compositions that are used provide effective removal of deposits, while not contributing to the problems of emulsification and corrosion.

The compositions of the present invention include at least one organic oil-soluble or oil-miscible acid and at least one multi-polyether-headed surfactant. Desirably, the composition will include at least one organic solvent. Also, it is desirable to provide a composition that is substantially free of water. This prevents the corrosion problems that are demonstrated by an aqueous solution of a strong acid.

The organic oil-soluble or oil-miscible acids of the present invention will be able to form water-soluble salts and complexes from the substantially insoluble deposits. These deposits include, without limitation, NH₄Cl, CaCO₂, FeO₂H, and FeS. Desirably, the acid will have a pKₐ that is lower than that of CO₂ or H₂S. Therefore, an acid having a pKₐ of 4 or less, or more desirably 2 or less, is preferred. These acids include, but are not limited to phosphonic acids, sulfonic acids, oxalic acids, and aluminum chlorohydric acids. More specific examples include hydroxyethylidene diphosphonic acid (HEDP), dodecylbenzene sulfonic acid (DDBSA), dinonylnaphthalene sulfonic acid (DNNSA), oxalic acid, partial esters of oxalic acid, aluminum chlorohydric glycolates, and aluminum chlorohydrate.

The multi-polyether-headed surfactants (MPEHS) of the present invention include those with hydrophobes (tails), such as C₃ to C₂₅ alkyl, alkylaryl, alkylether diols or alkylether polyols; C₃ to C₂₅ alkyl or alkylaryl 1° or 2° amines; and C₃ to C₁₈ alkylphenolic resins having a degree of polymerization greater than or equal to 2. These are adducted with two or more hydrophilic heads per hydrophobe comprising chains of poly (C₂ to C₃ alkylene oxide) having a degree of polymerization from 2 to 30. Both the hydrophobes and hydrophiles can be covalently linked directly to one or more other hydrophobic or hydrophilic moities respectively, or linked together via reaction with alkenes, aldehydes, carboxylic acids, epoxides, isocyanates, ketones, or other linkage groups. The MPEHS may include branched nonylphenol-formaldehyde resins of degree of polymerization 4 to 8 adducted with 4 to 8 chains of poly(ethylene oxide) of degree of polymerization 4 to 7, blended with polypropylether diols or triols of degree of polymerization 15 to 25 adducted with 2 or 3 chains of poly(ethylene oxide) of degree of polymerization 13 to 22. More specific examples of useful MPEHS include branched nonylphenol-formaldehyde resins of degree of polymerization 4 to 8 adducted to 4 to 8 chains of poly(ethylene oxide) of degree of polymerization 4 to 7, branched nonylphenol adducted to one chain of poly(ethylene oxide) of degree of polymerization 15 to 25, and polypropylether triol of degree of polymerization 15 to 25 per OH adducted to 3 chains of poly(ethylene oxide) of degree of polymerization 13 to 22, two C₁₂ to C₂₀ carboxylic acids adducted to one chain of poly(ethylene oxide) of degree of polymerization 10 to 20.

Nominally emulsifying, mono-polyether-headed surfactants, such as a C₃ to C₁₈ alkylphenol or C₃ to C₂₅ carboxylic acid connected to one chain of poly(C₂ to C₃ alkylene oxide) of degree of polymerization 4 to 22, can be incorporated into an MPEHS formulation provided that the amount relative to an MPEHS with more than two heads in the blend, e.g. a resin of degree of polymerization from 4 to 8, is small enough that the average number of heads per surfactant in the blend is still at least two.

There is a variety of organic solvents that are useful for the present invention. These include, but are not limited to, aromatic solvents, glycol ether solvents, and alcoholic solvents. Specific examples of useful organic solvents include xylenes, aromatic naphthas, alkoxyethanols, glymes, C₂-C₆ glycols, C₁-C₂₂ alcohols, aromatic alcohols, and methyl benzyl alcohol.

Within the composition, the amounts of the components can vary. In general, the ratio of acid to MPEHS may vary from about 10:1 to about 1:10. The amount of acid in the total composition may vary from about 2% to about 60% by weight of the total composition, while the amount of MPEHS may vary from about 1% to about 50% by weight of the total composition, and the amount of organic solvent may vary from about 10% to about 97% by weight of the total composition.

The compositions of the present invention may be used to remove deposits from the interior surfaces of hydrocarbon processing equipment, desirably while the equipment is on-line. The composition may be added to the influent of the hydrocarbon processing equipment. The MPEHS serves to wet the mud and deposits, which are frequently coated with a layer of the hydrocarbon that is being processed. The MPEHS acts as a “tar removal” agent. This allows the acid to contact the salt deposits and convert them to water-soluble salts and water-soluble complexes. A water wash is then provided which removes the newly formed water-soluble salts and complexes. The water wash is performed with a water-based solution that optionally includes MPEHS.

A similar method is used to remove the water-insoluble salt containing mud or sludge deposits that form on the bottom surfaces of desalters. A composition of the present invention is first introduced to the desalter, desirably while the desalter is still in operation. The MPEHS of the composition wets the mud deposit, thereby allowing the acid to contact the salt deposits and convert them to water-soluble salts and water-soluble complexes. After the introduction of the composition, a mud-wash system such as those using jets of water is used to remove the newly formed water-soluble salts and complexes. The mud-wash system may optionally include at least one MPEHS.

### EXAMPLES

### Example 1

One problem that results from the deposits and corrosion products is exhibited in the heat exchangers. The result is an increase in both the back pressure on the distillation tower and the outlet temperature of the condensed vapors.

The following inventive composition based on percentage by weight was prepared:

| COMPONENT | % by weight |
|---|---|
| Heavy aromatic naphtha (HAN) | 48.5 |
| 96% DDBSA in HAN¹ | 43.0 |
| 80% branched nonylphenol-formaldehyde resins of dp 4 to | 6.0 |
| 8 connected to 4 to 8 chains of poly(ethylene oxide) of dp | |
| 4 to 7 in HAN² | |
| Branched nonylphenol connected to one chain of | 2.5 |
| poly(ethylene oxide) of dp 15 to 25³ | |

¹available as Witco 1298 Soft Acid, from Witco Corporation
²available as Arbreak 319, from Baker Chemical
³available as Igepal CO-850, from Rhodia Chemical, Inc.

While in operation, the exchangers were injected with 60 gal/hr of this product for two hours. They were then washed with water at 80 gal/min for 45 minutes. The MPEHS acted as a tar removal agent allowing the acid to form water-soluble salts and water-soluble complexes with the deposits and corrosion products. The subsequent water wash was able to remove the water-soluble salts and complexes from the equipment. The result was the overhead pressure and exchanger outlet temperature being dramatically reduced.

### Example 2

In another refinery the filters had become plugged with solid deposits.

The following inventive composition, based on percentage by weight, was prepared:

| COMPONENT | % by weight |
|---|---|
| Oxalic acid dihydrate (strong acid) | 14.3 |
| Glycolic acid (weak acid) | 14.3 |
| 83% branched nonylphenol-formaldehyde resins of dp 4 to | 9.5 |
| 8 connected to 4 to 8 chains of poly(ethylene oxide) of dp | |
| 4 to 7 in HAN¹ | |
| Polypropylether triol of dp 15 to 25 per OH connected to 3 | 4.7 |
| chains of poly(ethylene oxide) of dp 13 to 22² | |
| Butyl Carbitol [di(ethylene glycol) butyl ether] | 4.7 |
| Propylene Glycol | 52.5 |

¹available as Witbreak DRC-168B from Crompton Corporation
²available as Witbreak DTG-62 from Crompton Corporation

This composition was added to the desalter ahead of the filters. This was followed by a water wash. The MPEHS acted as a tar removal agent allowing the acid to form water-soluble salts and water-soluble complexes with the deposits and corrosion products. The subsequent water wash was able to remove the water-soluble salts and complexes from the equipment, thereby clearing the filters.

### Example 3

This example demonstrates use of the present invention as a means for removing mud or sludge deposits in a desalter apparatus. Distinct differences in temperature at selected locations of the desalter as compared to the general temperature of the apparatus of hydrocarbon stream flowing therethrough, are indicative of mud or sludge deposit build-up.

In a desalter that has mud or sludge deposits that have settled to the bottom, the present invention can be used for online cleaning. Evidence of the deposits can be discovered by measuring the temperature at different locations within the desalter during its operation. For example, lower temperature spots in the desalter as compared to the average temperature in the desalter are indicative of mud and sludge deposits. These occur especially at the bottom and comers of the desalter.

In order to remove these mud deposits, a composition of the present invention was prepared including as acid component aluminum chlorohydrate in a glycol solvent commercially available as Chlorhydrol 50% from VWR and a melamine formaldehyde resin commercially available as Exxon JAYFLOC-824 added to clarify the effluent water. Each of these components were added to the influent representative of the desalter initially at concentrations of about 0.5 ppm to about 1.0 ppm. Throughout the process, the concentration varied from about 1.0 ppm to about 8.0 ppm with an average of about 3.0 ppm.

A mud wash was then initiated by directing jets of water in combination with a composition including a MPEHS Witbreak DRC-164 (80% branched nonylphenol-formaldehyde resins of dp 4 to 8 connected to 4 to 8 chains of poly(ethylene oxide) of dp 2 to 5 in HAN), available from Crompton Corporation, a MPEHS PEG 600 DOT (2 C₁₂ to C₂₀ carboxylic acids connected to one chain of poly(ethylene oxide) of dp 10 to 20, and the solvent Butyl Carbitol [di(ethylene glycol) butyl ether].

The MPEHS addition served to wet the mud and return the organic coating to the hydrocarbon being processed. The acid successfully converted the deposits to water-soluble salts and complexes which were then removed by the water wash. This is evidenced by the lack of substantially lower temperature spots and more uniform temperature readings at various locations on the desalter following the treatment.

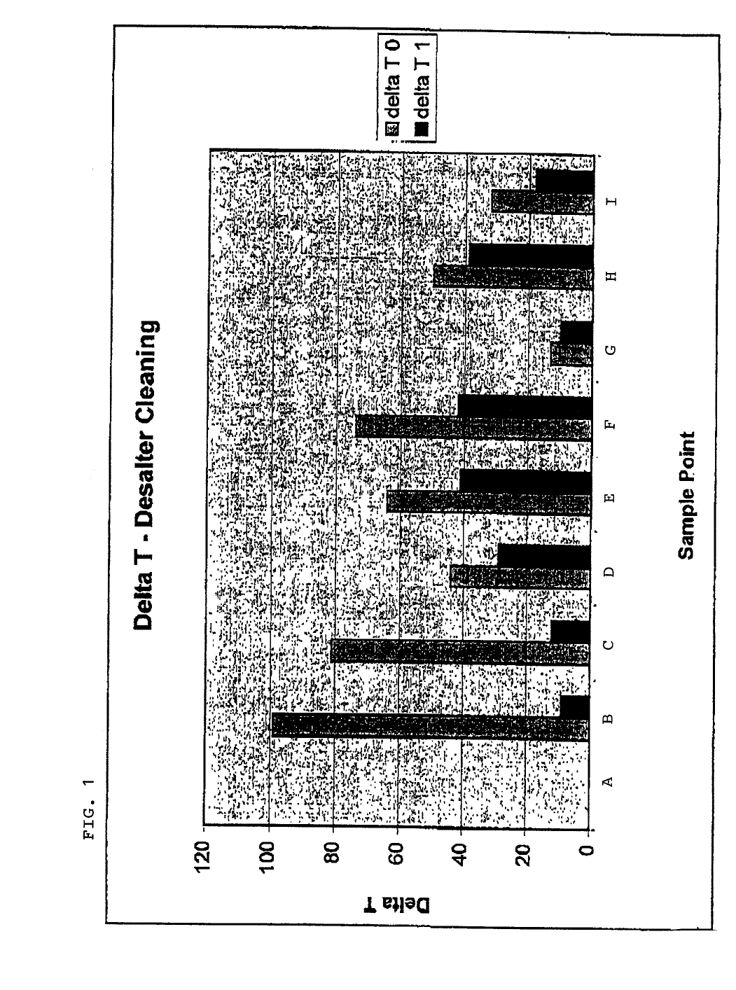

FIG. 1 is a bar graph that provides data that demonstrate the successful removal of mud and sludge deposits from a desalter. The location of deposits are indicated by a lower temperature reading in particular areas of the desalter, especially on the bottom and around the corners. In a desalter that has mud and sludge deposits, a difference in temperature between the hydrocarbon being processed in the desalter and the particular areas on the desalter will be noted. The larger the deposit is, the greater the difference in temperature will be.

The desalter referred to in FIG. 1 is a conventional, generally cylindrical desalter. Each of the “Sample Points” (A-I) is a location on the desalter where a temperature reading was taken. Sample points A-F were taken at points on the end of the desalter, while points G-I were taken along the length of the desalter tank. Point A was located at the center of the end of the tank, while point B was located at the end of the tank at the bottom. The remainder of points C-F were located below point A, in order of highest to lowest, in the order of D, E, F, C. The remaining three points G, H, and I were located along the length of the tank with I being at the center of the tank on the bottom, H being approximately a quarter of the way along the length of the tank slightly above the bottom, and G being approximately an eighth of the way along the length of the tank and approximately a quarter of the height above the bottom of the tank.

Two measurements were made at each of the points as shown on the graph in FIG. 1. The first measurement was made before the treating (cleaning) desalter in accordance with this invention and is referred to as Time 0. The second measurement was made one week after the desalter cleaning and is referred to as Time 1. The dramatic decreases in delta T, measured in ° F., show that the removal of deposits was successfully completed.

While there have been described what are presently believed to be the preferred embodiments of the invention, those skilled in the art will realize that changes and modifications may be made thereto without departing from the spirit of the invention, and it is intended to include all such changes and modifications as fall within the true scope of the invention.

What is claimed is:

1. A composition for removing salt-containing deposits from the surface of hydrocarbon processing equipment comprising:
at least one organic oil-soluble or oil-miscible acid, and
at least one multi-polyether-headed surfactant.

2. The composition of claim 1 further comprising at least one organic solvent.

3. The composition of claim 2 wherein said acid has a pKₐ of 4 or less.

4. The composition of claim 2 wherein said acid has a pKₐ of 2 or less.

5. The composition of claim 2 wherein said acid is selected from the group consisting of phosphonic acids, sulfonic acids, oxalic acids, aluminum chlorohydric acids and combinations thereof.

6. The composition of claim 2 wherein said acid is selected from the group consisting of hydroxyethylidene diphosphonic acid (HEDP), dodecylbenzene sulfonic acid (DDBSA), dinonylnaphthalene sulfonic acid (DNNSA), oxalic acid, partial esters of oxalic acid, aluminum chlorohydric glycolates, aluminum chlorohydrate, and combinations thereof.

7. The composition of claim 2 wherein said multi-polyether-headed surfactant comprises at least one hydrophobe selected from the group consisting of C₃ to C₂₅ alkyl, C₃ to C₂₅ alkylaryl, C₃ to C₂₅ alkylether diols or C₃ to C₂₅ alkylether polyols, C₃ to C₂₅ alkyl or alkylaryl 1° amines, C₃ to C₂₅ alkyl or alkylaryl 2° amines, and C₃ to C₁₈ alkylphenolic resins having a degree of polymerization greater than or equal to 2, adducted with two or more hydrophilic heads per hydrophobe comprising chains of poly (C₂ to C₃ alkylene oxide) having a degree of polymerization from 2 to 30.

8. The composition of claim 7 wherein said hydrophobes and said hydrophilic heads of said multi-polyether-headed surfactants are crosslinked with one or more members selected from the group consisting of alkenes, aldehydes, carboxylic acids, epoxides, isocyanates, and ketones.

9. The composition of claim 2 wherein said multi-polyether-headed surfactant comprises at least one of branched nonylphenol-formaldehyde resins of degree of polymerization 4 to 8 adducted with 4 to 8 chains of poly(ethylene oxide) of degree of polymerization 4 to 7, blended with polypropylether diols or triols of degree of polymerization 15 to 25 adducted with 2 or 3 chains of poly(ethylene oxide) of degree of polymerization 13 to 22.

10. The composition of claim 2 wherein said multi-polyether-headed surfactant is selected from the group consisting of branched nonylphenol-formaldehyde resins of degree of polymerization 4 to 8 adducted to 4 to 8 chains of poly(ethylene oxide) of degree of polymerization 4 to 7, branched nonylphenol adducted to one chain of poly(ethylene oxide) of degree of polymerization 15 to 25, polypropylether triol of degree of polymerization 15 to 25 per OH adducted to 3 chains of poly(ethylene oxide) of degree of polymerization 13 to 22, two C₁₂ to C₂₀ carboxylic acids adducted to one chain of poly(ethylene oxide) of degree of polymerization 10 to 20, and blends thereof.

11. The composition of claim 2 wherein said solvent is selected from the group consisting of aromatic solvents, glycol ether solvents, alcoholic solvents and combinations thereof.

12. The composition of claim 2 wherein said solvent is selected from the group consisting of xylenes, aromatic naphthas, alkoxyethanols, glymes, C₂-C₆ glycols, C₁-C₂₂ alcohols, aromatic alcohols, methyl benzyl alcohol and combinations thereof.

13. The composition of claim 2 wherein said acid comprises about 2% to about 60% by weight of the total composition.

14. The composition of claim 2 wherein said multi-polyether-headed surfactant comprises about 1% to about 30% by weight of the total composition.

15. The composition of claim 2 wherein said solvent comprises about 10% to about 97% by weight of the total composition.

16. A method of removing salt-containing deposits from the surface of hydrocarbon processing equipment comprising the following steps:
a) providing a composition comprising at least one organic oil-soluble or oil-miscible acid and at least one multi-polyether-headed surfactant,
b) adding said composition to influent of said hydrocarbon processing equipment, and
c) subsequently adding a water-based solution to said effluent.

17. The method of claim 16 wherein said water-based solution comprises at least one multi-polyether-headed surfactant and water.

18. The method of claim 16 wherein said removing is conducted during online processing of said hydrocarbon processing equipment.

19. The method of claim 16 wherein said composition further comprises at least one organic solvent.

20. The method of claim 19 wherein said acid has a pKₐ of 4 or less.

21. The method of claim 19 wherein said acid has a pKₐ of 2 or less

22. The method of claim 19 wherein said acid is selected from the group consisting of phosphonic acids, sulfonic acids, oxalic acids, aluminum chlorohydric acids and combinations thereof.

23. The method of claim 19 wherein said acid is selected from the group consisting of hydroxyethylidene diphosphonic acid (HEDP), dodecylbenzene sulfonic acid (DDBSA), dinonylnaphthalene sulfonic acid (DNNSA), oxalic acid, partial esters of oxalic acid, aluminum chlorohydric glycolates, aluminum chlorohydrate, and combinations thereof.

24. The method of claim 19 wherein said multi-polyether-headed surfactant comprises at least one hydrophobe selected from the group consisting of C₃ to C₂₅ alkyl, C₃ to C₂₅ alkylaryl, C₃ to C₂₅ alkylether diols or C₃ to C₂₅ alkylether polyols, C₃ to C₂₅ alkyl or alkylaryl 1° amines, C₃ to C₂₅ alkyl or alkylaryl 2° amines, and C₃ to C₁₈ alkylphenolic resins having a degree of polymerization greater than or equal to 2; adducted with two or more hydrophilic heads per hydrophobe comprising chains of poly (C₂ to C₃ alkylene oxide) having a degree of polymerization from 3 to 30.

25. The method of claim 24 wherein said hydrophobes and said hydrophilic heads of said multi-polyether-headed surfactants are crosslinked with one or more members selected from group consisting of alkenes, aldehydes, carboxylic acids, epoxides, isocyanates, and ketones.

26. The method of claim 19 wherein said multi-polyether-headed surfactant comprises at least one of branched nonylphenol-formaldehyde resins of degree of polymerization 4 to 8 adducted with 4 to 8 chains of poly(ethylene oxide) of degree of polymerization 4 to 7, blended with polypropylether diols or triols of degree of polymerization 15 to 25 adducted with 2 or 3 chains of poly(ethylene oxide) of degree of polymerization 13 to 22.

27. The method of claim 19 wherein said multi-polyether-headed surfactant is selected from the group consisting of branched nonylphenol-formaldehyde resins of degree of polymerization 4 to 8 adducted to 4 to 8 chains of poly(ethylene oxide) of degree of polymerization 2 to 7, branched nonylphenol adducted to one chain of poly(ethylene oxide) of degree of polymerization 15 to 25, polypropylether triol of degree of polymerization 15 to 25 per OH adducted to 3 chains of poly(ethylene oxide) of degree of polymerization 13 to 22, two C₁₂ to C₂₀ carboxylic acids adducted to one chain of poly(ethylene oxide) of degree of polymerization 10 to 20, and blends thereof.

28. The method of claim 19 wherein said solvent is selected from the group consisting of aromatic solvents, glycol ether solvents, alcoholic solvents and combinations thereof.

29. The method of claim 19 wherein said solvent is selected from the group consisting of xylenes, aromatic naphthas, alkoxyethanols, glymes, C₂-C₆ glycols, C₁-C₂₂ alcohols, aromatic alcohols, methyl benzyl alcohol and combinations thereof.

30. The method of claim 19 wherein said acid comprises about 2% to about 60% by weight of the total composition.

31. The method of claim 19 wherein said multi-polyether-headed surfactant comprises about 1% to about 30% by weight of the total composition.

32. The method of claim 19 wherein said solvent comprises about 10% to about 97% by weight of the total composition.

33. The method of claim 19 wherein said water-based solution further comprises at least one multi-polyether-headed surfactant.

34. A method of removing salt-containing mud deposits from a crude oil desalter comprising the following steps:
a) providing a composition comprising at least one organic oil-soluble or oil-miscible acid and at least one multi-polyether-headed surfactant,
b) adding said composition to said desalter, and
c) optionally, subsequently introducing a mud-wash system to said desalter.

35. The method of claim 34 wherein said mud-wash system further comprises at least one multi-polyether-headed surfactant.

36. The method of claim 34 wherein said removing is conducted while said desalter is in operation.

37. The method of claim 34 wherein said composition further comprises at least one organic solvent.

38. A kit for removing salt deposits from a surface comprising:
at least one organic oil-soluble or oil-miscible acid,
at least one multi-polyether-headed surfactant, and
at least one organic solvent.

39. A composition for removing salt-containing deposits from the surfaces of hydrocarbon processing equipment comprising:
at least one oil-soluble or oil-miscible organic acid,
at least one multi-polyether headed surfactant, and
at least one organic solvent,
said composition being substantially free of water.

40. A composition for removing salt-containing deposits from the surfaces of hydrocarbon processing equipment comprising:
at least one organic oil-soluble or oil-miscible acid which converts substantially water-insoluble deposits into water-soluble salts or water-soluble complexes,
at least one multi-polyether headed surfactant acting as a tar removal agent that does not emulsify water with hydrocarbons, and
at least one organic solvent.

41. A method of forming a removable complex for removing salt-containing deposits from the surfaces of hydrocarbon processing equipment comprising the following steps:
a) providing a composition comprising at least one organic oil-soluble or oil-miscible acid and at least one multi-polyether-headed surfactant,
b) contacting said deposit with said composition for a time sufficient to allow said deposit to be converted to a water-soluble salt or water-soluble complex, and
c) flushing said salt or said complex with an aqueous solution to remove said salt or said complex.
